(19) United States
(12) Patent Application Publication
(10) Pub. No.: US 2009/0262688 A1
(43) Pub. Date: Oct. 22, 2009

(54) RATE ADAPTATION METHODS FOR WIRELESS COMMUNICATION APPARATUS, AND WIRELESS COMMUNICATION APPARATUS FOR PERFORMING WIRELESS COMMUNICATION WITH RATE ADAPTATION

(76) Inventors: Shang-Ho Tsai, Kaohsiung City (TW); Hsuan-Yu Liu, Taipei City (TW); Hung-Wen Yang, Hsinchu City (TW); Tai-Cheng Liu, Kaohsiung City (TW); Yuh-Ren Jauh, Tao-Yuan (TW)

Correspondence Address: NORTH AMERICA INTELLECTUAL PROPERTY CORPORATION, P.O. BOX 506, MERRIFIELD, VA, 22116, US

(21) Appl. No.: 12/107,078

(22) Filed: Apr. 22, 2008

(51) Int. Cl. H04Q 7/00

(52) U.S. Cl. 370/329

(57) ABSTRACT

A rate adaptation method for a wireless communication apparatus includes: determining whether to use a first mode or a second mode according to at least one estimation value, where the first mode and the second mode correspond to different values of an overall data rate of the wireless communication apparatus. A wireless communication apparatus for performing wireless communication with rate adaptation includes: a processing circuit; and a wireless receiver and a wireless transmitter, both coupled to the processing circuit. The processing circuit determines at least one estimation value regarding communication quality of the wireless communication apparatus, and further determines whether to use a first mode or a second mode according to the estimation value, where the first mode and the second mode correspond to different values of an overall data rate of the wireless communication apparatus.

### BACKGROUND

The present invention relates to rate adaptation for wireless communications, and more particularly, to rate adaptation methods for a wireless communication apparatus, and to a wireless communication apparatus for performing wireless communication with rate adaptation.

Please refer to FIG. 1. FIG. 1 illustrates a rate selection method utilized in a conventional wireless local area network (WLAN) device complying with IEEE 802.11n specifications, where the data rate of the conventional WLAN device can be changed in accordance with a transmission bandwidth. More specifically, according to 802.11n specifications, the transmission bandwidth can be 20 MHz or 40 MHz, so corresponding modes such as a 20 MHz mode or a 40 MHz mode can be alternatively selected. The 40 MHz bandwidth is typically divided into an upper 20 MHz (U20) bandwidth and a lower 20 MHz (L20) bandwidth. A primary channel and a secondary channel respectively having 20 MHz bandwidths are available when the 40 MHz bandwidth is supported.

According to the related art, when it is detected that the secondary channel is idle, the conventional WLAN device uses the 40 MHz mode as shown in FIG. 1. Here, the criterion for determining whether the secondary channel is idle is the same as that in 9.20.2 of IEEE 802.11n specifications. When the secondary channel has been idle for a duration of at least PIFS immediately preceding the expiration of the backoff counter, the secondary channel is considered idle.

In some occasions, however, when using the 40 MHz mode as determined according to the rate selection method shown in FIG. 1, the conventional WLAN device may encounter problems such as co-channel interference and/or a low packet error rate (PER) due to serious fading, typically causing decreased performance of the conventional WLAN device compared to the 20 MHz mode.

### SUMMARY

It is therefore an objective of the claimed invention to provide rate adaptation methods for a wireless communication apparatus, and to provide a wireless communication apparatus for performing wireless communication with rate adaptation, in order to solve the aforementioned problems.

It is another objective of the claimed invention to provide rate adaptation methods for a wireless communication apparatus, and to provide a related apparatus, in order to enhance the overall performance of the wireless communication apparatus.

An exemplary embodiment of a rate adaptation method for a wireless communication apparatus comprises: determining at least one estimation value regarding communication quality of the wireless communication apparatus; and determining whether to use a first mode or a second mode according to the estimation value, where the first mode and the second mode correspond to different values of an overall data rate of the wireless communication apparatus.

An exemplary embodiment of a rate adaptation method for a wireless communication apparatus which is within a wireless communication system utilizing a primary channel and a secondary channel comprises: detecting whether the secondary channel is idle; and determining whether to use a first bandwidth mode or a second bandwidth mode according to whether the secondary channel is idle and according to at least one estimation value corresponding to communication quality of the primary channel and/or the secondary channel, wherein the first bandwidth mode and the second bandwidth mode correspond to different values of an overall data rate of the wireless communication apparatus.

An exemplary embodiment of a rate adaptation method for a wireless communication apparatus comprises: determining at least one estimation value regarding communication quality of the wireless communication apparatus; and determining whether to use a first guard interval (GI) mode or a second GI mode according to the estimation value, wherein the first GI mode and the second GI mode correspond to different values of an overall data rate of the wireless communication apparatus.

An exemplary embodiment of a wireless communication apparatus for performing wireless communication with rate adaptation comprises: a processing circuit; and a wireless receiver and a wireless transmitter, both coupled to the processing circuit. The processing circuit determines at least one estimation value regarding communication quality of the wireless communication apparatus, and further determines whether to use a first mode or a second mode according to the estimation value, where the first mode and the second mode correspond to different values of an overall data rate of the wireless communication apparatus. In addition, the wireless receiver receives data wirelessly according to the control of the processing circuit. Additionally, the wireless transmitter transmits data wirelessly according to the control of the processing circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a rate selection method utilized in a conventional wireless local area network (WLAN) device complying with IEEE 802.11n specifications.

FIG. 2 is a diagram of a wireless communication apparatus for performing wireless communication with rate adaptation according to a first embodiment of the present invention.

FIG. 3 is a flowchart of a rate adaptation method for a wireless communication apparatus according to one embodiment of the present invention.

FIG. 4 is a flowchart of a rate adaptation method for a wireless communication apparatus according to another embodiment of the present invention, where this embodiment is a variation of the embodiment shown in FIG. 3.

FIG. 5 is a flowchart of a rate adaptation method for a wireless communication apparatus according to another embodiment of the present invention, where this embodiment is also a variation of the embodiment shown in FIG. 3, and is further a variation of the embodiment shown in FIG. 4.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

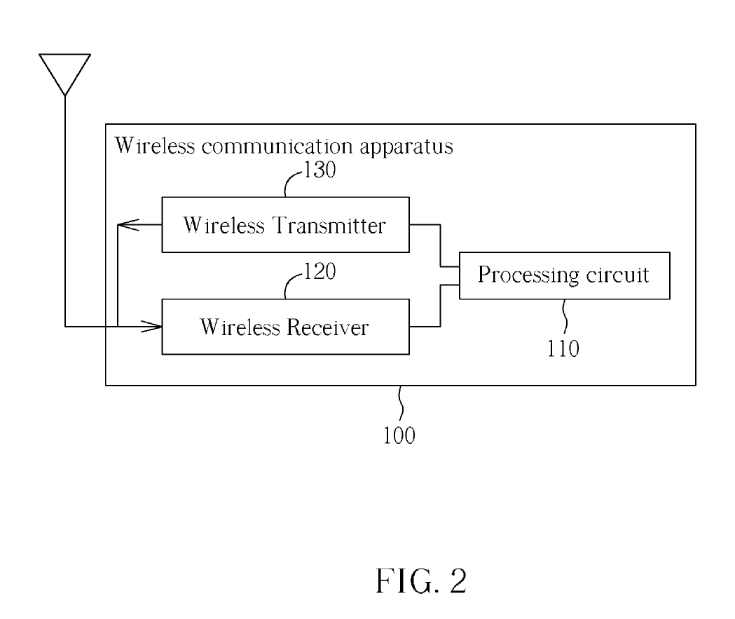

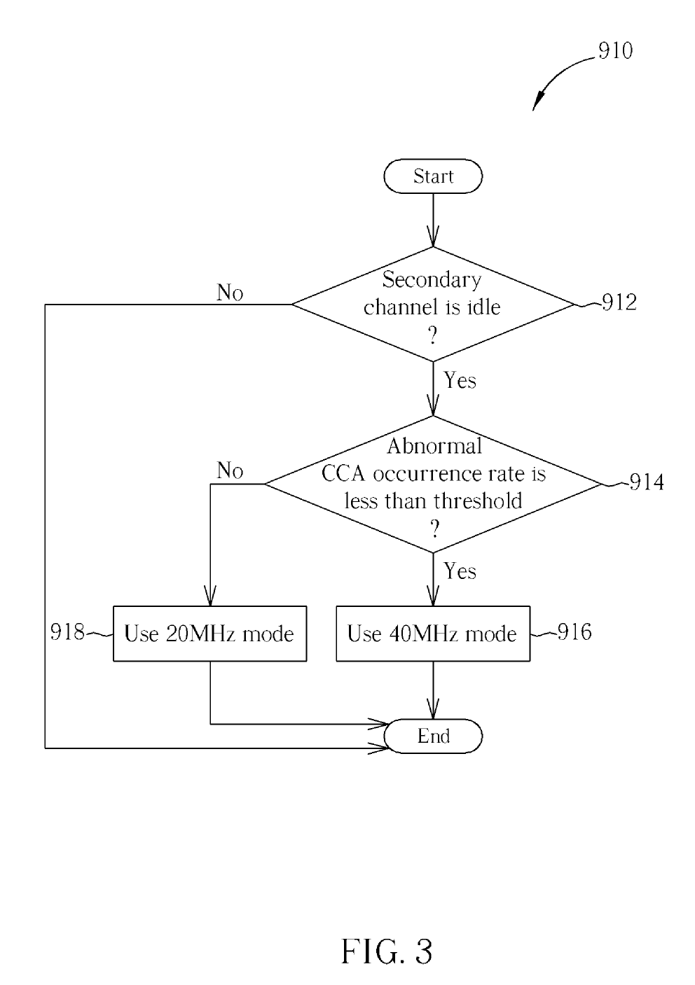

Please refer to FIG. 2 and FIG. 3. FIG. 2 is a diagram of a wireless communication apparatus 100 for performing wireless communication with rate adaptation according to a first embodiment of the present invention. FIG. 3 is a flowchart of a rate adaptation method 910 for a wireless communication apparatus according to one embodiment of the present invention. The rate adaptation method 910 can be applied to the wireless communication apparatus 100 shown in FIG. 2, and can be implemented with the wireless communication apparatus 100 shown in FIG. 2.

As shown in FIG. 2, the wireless communication apparatus 100 of this embodiment comprises a processing circuit 110 for implementing a rate adaptation method such as the rate adaptation method 910 shown in FIG. 3. According to a first implementation choice of this embodiment (i.e. a special case of this embodiment), the processing circuit 110 is implemented with an application-specific integrated circuit (ASIC). According to a second implementation choice of this embodiment (i.e. another special case of this embodiment), the processing circuit 110 is implemented with a micro-processing unit (MPU) executing a firmware code. According to a third implementation choice of this embodiment (i.e. another special case of this embodiment), the processing circuit 110 is implemented with a processing unit executing a software code. In addition, the wireless communication apparatus 100 of this embodiment further comprises a wireless receiver 120 and a wireless transmitter 130, both coupled to an antenna as shown in FIG. 2. According to the control of the processing circuit 110, the wireless receiver 120 receives data wirelessly and the wireless transmitter 130 transmits data wirelessly.

According to this embodiment, the processing circuit 110 determines at least one estimation value regarding communication quality of the wireless communication apparatus 100, and further determines whether to use a first mode or a second mode according to the estimation value. Here, the first mode and the second mode correspond to different values of an overall data rate of the wireless communication apparatus 100. In this embodiment, the first mode represents a first bandwidth mode, and the second mode represents a second bandwidth mode. More particularly, in this embodiment, the first bandwidth mode corresponds to a greater value of the overall data rate than that of the second bandwidth mode. In addition, the wireless communication apparatus 100 of this embodiment is within a wireless communication system utilizing a primary channel and a secondary channel, where the estimation value of this embodiment corresponds to communication quality of the primary channel and/or the secondary channel for being utilized by the wireless communication apparatus 100.

In practice, the wireless communication apparatus 100 operates by utilizing Orthogonal Frequency Division Multiplexing (OFDM) modulation, where the data rate of wireless communication apparatus 100 can be changed adaptively in accordance with a transmission bandwidth. For example, the transmission bandwidth can be 20 MHz or 40 MHz as defined in 802.11n specifications, so the corresponding bandwidth modes such as a 20 MHz mode or a 40 MHz mode can be adaptively selected.

For better comprehension, the 40 MHz bandwidth is exemplarily divided into an upper 20 MHz (U20) bandwidth and a lower 20 MHz (L20) bandwidth as mentioned above. In addition, the primary channel and the secondary channel of this embodiment respectively have 20 MHz bandwidths within the 40 MHz bandwidth (e.g. the U20 bandwidth and the L20 bandwidth), where the primary channel and the secondary channel are available when the 40 MHz bandwidth is supported. Thus, in this embodiment, the primary channel and the secondary channel both represent frequency bands.

According to this embodiment, the processing circuit 110 determines whether to use the first bandwidth mode (e.g. the 40 MHz mode) or the second bandwidth mode (e.g. the 20 MHz mode) according to whether the secondary channel is idle and according to the estimation value mentioned above. In addition, the estimation value of this embodiment represents an abnormal clear channel assessment (CCA) occurrence rate regarding the primary channel and/or the secondary channel. More specifically, the abnormal CCA occurrence rate of this embodiment represents the occurrence rate of an event that the primary channel is idle but the secondary channel is not idle.

Regarding this, according to the flowchart shown in FIG. 3, detailed operations of the wireless communication apparatus 100 can be further described as follows.

In Step 912, the processing circuit 110 determines whether the secondary channel is idle, where the processing circuit 110 of this embodiment determines whether the secondary channel is idle by detecting whether the secondary channel has been idle for a specific duration. According to this embodiment, the criterion for determining whether the secondary channel is idle in this embodiment can be the same as that in 9.20.2 of IEEE 802.11n specifications. For example, when the secondary channel has been idle for the specific duration such as a duration of at least PIFS immediately preceding the expiration of the backoff counter, the secondary channel is considered idle.

As shown in FIG. 3, when the processing circuit 110 determines that the secondary channel is idle, Step 914 is entered; otherwise, all intermediate steps starting from Step 914 are skipped.

In Step 914, the processing circuit 110 determines whether to use the first bandwidth mode (e.g. the 40 MHz mode) or the second bandwidth mode (e.g. the 20 MHz mode) according to the abnormal CCA occurrence rate. As shown in FIG. 3, when the processing circuit 110 determines that the abnormal CCA occurrence rate is less than a threshold, Step 916 is entered and the processing circuit 110 determines to use the 40 MHz mode. In addition, when the processing circuit 110 determines that the abnormal CCA occurrence rate reaches the threshold, Step 918 is entered and the processing circuit 110 determines to use the 20 MHz mode.

As a result, when the secondary channel is idle and the abnormal CCA occurrence rate does not reach the threshold, the processing circuit 110 determines to use the first bandwidth mode; otherwise, the processing circuit 110 determines to use the second bandwidth mode.

In this embodiment, the event that the primary channel is idle but the secondary channel is not idle can be referred to as the “abnormal CCA events” since these kind of events are not allowed according to 11n standard but may occur due to co-channel interference. By applying the method 910 shown in FIG. 3, related art problems such as data rate deterioration due to co-channel interference can be prevented.

According to a variation of this embodiment, the criterion for determining whether the secondary channel is idle can be different from that in 9.20.2 of IEEE 802.11n specifications. For example, when the secondary channel has been idle for a specific duration determined according to some other specifications, the secondary channel is considered idle.

According to another variation of this embodiment, the idle detection operation of Step 912 and the abnormal CCA occurrence detection operation of Step 914 can be performed at the same time, where the criteria for determining whether to enter Step 916 or Step 918 can be implemented with a predetermined table to achieve the same results as those of the method 910 shown in FIG. 3.

According to another variation of this embodiment, Step 912 and Step 914 can be executed in a reversed order, where the criteria for determining whether to enter Step 916 or Step 918 can be implemented with a predetermined table to achieve the same results as those of the method 910 shown in FIG. 3.

According to another variation of this embodiment, the whole operation shown in FIG. 3 can be performed repeatedly.

According to another variation of this embodiment, a pseudo code specifies practical steps for implementing similar operations as mentioned above. First, some basic definitions are listed below:
(a) the listening period is Q μsec;
(b) the percentage of abnormal CCA is obtained every Q μsec;
(c) the resolution of this listen mechanism is Lr μsec; and
(d) the abnormal CCA event is defined as a CCA occurring only in the secondary channel within Lr μsec.

Since the resolution is Lr μsec, there are Q/Lr time slots for Q μsec. The pseudo code can be described as follows.
S1-1: Cnt_Time=0, Cnt_Abnormal_CCA=0.
S1-2: If there is an abnormal CCA, Cnt_Abnormal_CCA++ and Cnt_Time++; otherwise, only Cnt_Time++.
S1-3: If Cnt_Time >=Q/Lr, go to S1-4; otherwise, go to S1-2.
S1-4: If the ratio Cnt_Abnormal_CCA/(Q/Lr)>P, X_CCA_FLAG=1; otherwise, X_CCA_FLAG=0. Go to S1-1.

In Line S1-4 of the pseudo code listed above, when the ratio Cnt_Abnormal_CCA/(Q/Lr) is greater than the threshold P, the flag X_CCA_FLAG is raised to indicate that the abnormal CCA occurrence rate reaches the threshold P; otherwise, the flag X_CCA_FLAG is set as zero. Then, Line S1-1 is re-entered to repeat the whole pseudo code.

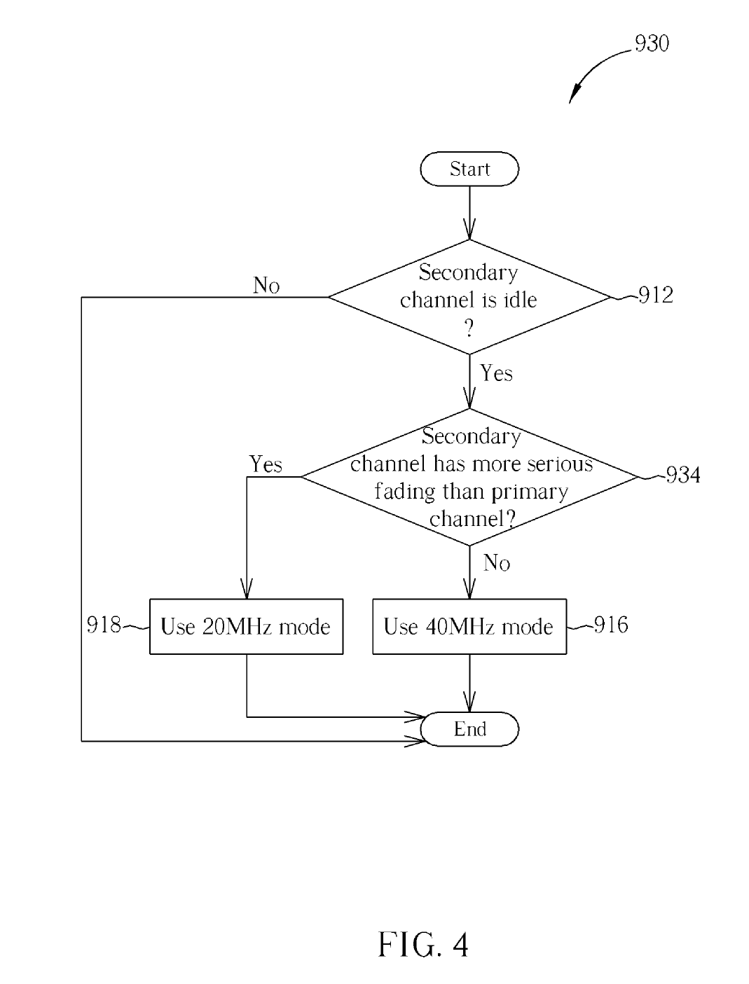

FIG. 4 is a flowchart of a rate adaptation method 930 for a wireless communication apparatus according to another embodiment of the present invention, where this embodiment is a variation of the embodiment shown in FIG. 3. Similarly, the rate adaptation method 930 can be applied to the wireless communication apparatus 100 shown in FIG. 2, and can be implemented with the wireless communication apparatus 100 shown in FIG. 2. Step 914 mentioned above is replaced with Step 934 in the embodiment shown in FIG. 4, however.

According to this embodiment, the processing circuit 110 determines a plurality of estimation values corresponding to fading degrees of the primary channel and the secondary channel, respectively. In Step 934, the processing circuit 110 determines whether to use the first bandwidth mode (e.g. the 40 MHz mode) or the second bandwidth mode (e.g. the 20 MHz mode) according to whether the secondary channel has more serious fading than the primary channel. As shown in FIG. 4, when the processing circuit 110 determines that the secondary channel does not have more serious fading than the primary channel, Step 916 is entered and the processing circuit 110 determines to use the 40 MHz mode. In addition, when the processing circuit 110 determines that the secondary channel has more serious fading than the primary channel, Step 918 is entered and the processing circuit 110 determines to use the 20 MHz mode.

As a result, when the secondary channel is idle and the secondary channel does not have more serious fading than the primary channel, the processing circuit 110 determines to use the first bandwidth mode; otherwise, the processing circuit 110 determines to use the second bandwidth mode.

According to a variation of this embodiment, a pseudo code regarding judgment via constellation errors specifies practical steps for implementing similar operations as mentioned above. In this variation, the estimation values represent constellation errors of the primary channel and the secondary channel, respectively. In addition, the processing circuit 110 measures the constellation errors of the primary channel and the secondary channel, respectively. The pseudo code can be described as follows.
S2-1: Cnt_Tone_Err=0. Let Sₖ be the received constellation point at subcarrier k and Hₖ be the hard decision result of Sₖ. For pilot tones and/or data tones, calculate any one of the following parameters:
   (1) noise distance: |Sₖ−Hₖ|;
   (2) noise mean square error: |Sₖ−Hₖ|²; or
   (3) noise error: (Sₖ−Hₖ).
   For a specific frequency band (e.g. the U20 or L20 bandwidth mentioned above), if all tones are used, there are (N_SD+N_SP)/2 tones.
S2-2: If the calculated parameter for a specific tone is greater than THRES_ERR_DIST, Cnt_Tone_Err++. Perform the same procedure for all (N_SD+N_SP)/2 tones within a frequency band.
S2-3: If Cnt_Tone_Err>THRES_ERR_TONE for P packets, indicate that the secondary channel is not suitable for being used.

It is noted that Line S2-3 of the pseudo code listed above can also be replaced as follows.
S2-3′: If |Cnt_Tone_Err_{—}1−Cnt_Tone_Err_{—}2|>THRES_ERR_TONE for P packets, indicate that the secondary channel is not suitable for being used.

In Line S2-3′, Cnt_Tone_Err_{—}1 and Cnt_Tone_Err_{—}2 represent Cnt_Tone_Err for the primary channel and the secondary channel, respectively.

According to another variation of this embodiment, the judgment is based on tone energy instead of the constellation errors mentioned above. In this variation, the estimation values represent tone energy of the primary channel and the secondary channel, respectively. In addition, the processing circuit 110 measures the tone energy of the primary channel and the secondary channel, respectively.

In order to measure the tone energy, for example, the processing circuit 110 of this variation measures the average channel (band) power for the primary channel and the secondary channel, respectively. If the average channel power of the primary channel is greater than that of the secondary channel, and if a difference between the average channel power of the primary channel and the average channel power of the secondary channel reaches a threshold, the processing circuit 110 determines that the secondary channel is not suitable for transmission and determines to use the second bandwidth mode (e.g. the 20 MHz mode); otherwise, the processing circuit 110 determines that the secondary channel is suitable for transmission and determines to use the first bandwidth mode (e.g. the 40 MHz mode).

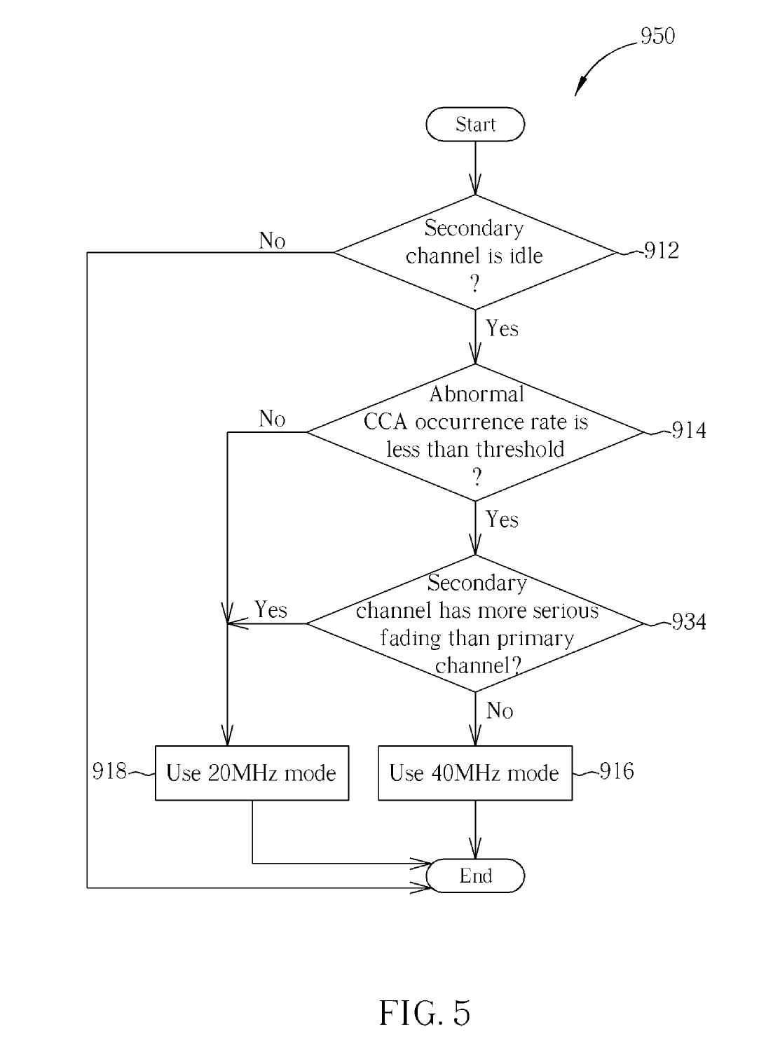

FIG. 5 is a flowchart of a rate adaptation method 950 for a wireless communication apparatus according to another embodiment of the present invention, where this embodiment is also a variation of the embodiment shown in FIG. 3, and is further a variation of the embodiment shown in FIG. 4. Similar descriptions are not repeated for this embodiment.

It is noted that, according to a variation of the embodiment shown in FIG. 5, Step 934 and Step 914 can be executed in a reversed order, where the criteria for determining whether to enter Step 916 or Step 918 can be implemented with a predetermined table to achieve the same results as those of the method 950 shown in FIG. 5.

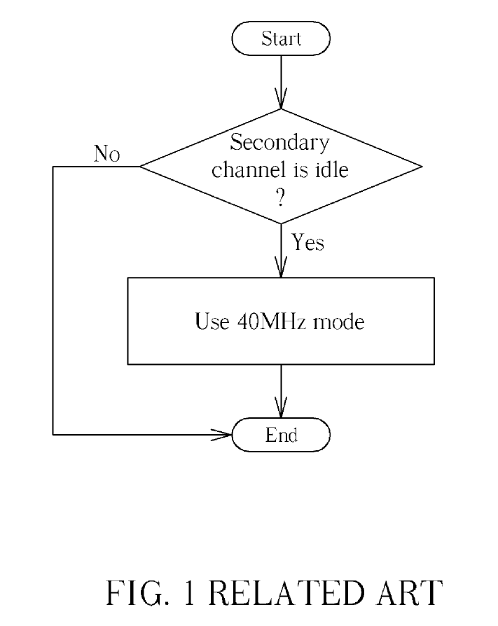

Regarding IEEE 802.11n applications, a conventional wireless device such as the conventional WLAN device utilizing the rate selection method shown in FIG. 1 merely detects whether the secondary channel is idle, whereby the 20 MHz mode or the 40 MHz mode is selected. As a result, an accuracy rate of determining whether the 20 MHz mode or the 40 MHz mode should be used is unacceptable. That is, erroneous decisions (e.g. a decision of using the 20 MHz mode when better performance can be achieved in the 40 MHz mode, and a decision of using the 40 MHz mode when better performance can be achieved in the 20 MHz mode) are made too frequently. On the contrary, by applying the rate adaptation methods of the present invention (e.g. the rate adaptation method 910 shown in FIG. 3, the rate adaptation method 930 shown in FIG. 4, and the rate adaptation method 950 shown in FIG. 5), the number of erroneous decisions can be greatly reduced.

According to a second embodiment, which is a variation of the first embodiment, the first mode represents a first guard interval (GI) mode, and the second mode represents a second GI mode, and the processing circuit 110 of this embodiment determines whether to use the first GI mode or the second GI mode by comparing the estimation value with a threshold.

More particularly, in this embodiment, the first GI mode represents a short GI mode, and the second GI mode represents a normal GI mode. According to the control of the processing circuit 110, the symbol duration can be changed by switching between the normal GI mode and the short GI mode, so that the data rate of the wireless communication apparatus 100 of this embodiment can be adaptively changed.

In this embodiment, when the estimation value reaches the threshold, the processing circuit 110 determines to use the short GI mode; otherwise, the processing circuit 110 determines to use the normal GI mode. In practice, the estimation value represents a received signal strength. For example, the processing circuit 110 measures the received signal strength. When the received signal strength reaches the threshold such as a threshold THRS_RSS, the processing circuit 110 determines to use the short GI mode; otherwise, the processing circuit 110 determines to use the normal GI mode.

The short GI mode is introduced in order to reduce transmission redundancy. The duration for a short GI is 400 ns, which is half of a normal GI. Thus, the short GI can be used in the channel environment whose delay spread is less than 400 ns. It is intuitive that a time domain impulse response of a channel can be utilized for judging whether it is appropriate to use the short GI. Unfortunately, to obtain the time domain impulse response of the channel, an FFT is required for converting an estimated frequency channel response to the time domain impulse response. In general, such extra complexity and corresponding high cost are not affordable in WLAN applications. According to the second embodiment, a rough estimation of channel condition(s) can be derived, in order to determine when to use short GIs. Therefore, the extra complexity and the corresponding high cost mentioned above are no longer required according to the present invention.

According to a variation of the second embodiment, the estimation value represents a transmission data rate instead of the received signal strength. For example, the processing circuit 110 monitors the transmission data rate. When the transmission data rate reaches the threshold such as a threshold THRS_RATE, the processing circuit 110 determines to use the short GI mode; otherwise, the processing circuit 110 determines to use the normal GI mode.

Those skilled in the art will readily observe that numerous modifications and alterations of the device and method may be made while retaining the teachings of the invention.

What is claimed is:

1. A rate adaptation method for a wireless communication apparatus, the wireless communication apparatus being within a wireless communication system utilizing a primary channel and a secondary channel, the rate adaptation method comprising:
detecting whether the secondary channel is idle; and
determining whether to use a first bandwidth mode or a second bandwidth mode according to whether the secondary channel is idle and according to at least one estimation value corresponding to communication quality of the primary channel and/or the secondary channel, wherein the first bandwidth mode and the second bandwidth mode correspond to different values of an overall data rate of the wireless communication apparatus.

2. The rate adaptation method of claim 1, wherein the estimation value represents an abnormal clear channel assessment (CCA) occurrence rate regarding the primary channel and/or the secondary channel; and the step of determining whether to use the first bandwidth mode or the second bandwidth mode further comprises:
determining whether to use the first bandwidth mode or the second bandwidth mode according to the abnormal CCA occurrence rate.

3. The rate adaptation method of claim 2, wherein the first bandwidth mode corresponds to a greater value of the overall data rate than that of the second bandwidth mode; and the step of determining whether to use the first bandwidth mode or the second bandwidth mode further comprises:
when the secondary channel is idle and the abnormal CCA occurrence rate does not reach a threshold, determining to use the first bandwidth mode; otherwise, determining to use the second bandwidth mode.

4. The rate adaptation method of claim 2, wherein the abnormal CCA occurrence rate represents the occurrence rate of an event that the primary channel is idle but the secondary channel is not idle.

5. The rate adaptation method of claim 1, wherein in the step of determining whether to use the first bandwidth mode or the second bandwidth mode, the at least one estimation value comprises a plurality of estimation values corresponding to fading degrees of the primary channel and the secondary channel, respectively; and the step of determining whether to use the first bandwidth mode or the second bandwidth mode further comprises:
determining whether to use the first bandwidth mode or the second bandwidth mode according to whether the secondary channel has more serious fading than the primary channel.

6. The rate adaptation method of claim 5, wherein the first bandwidth mode corresponds to a greater value of the overall data rate than that of the second bandwidth mode; and the step of determining whether to use the first bandwidth mode or the second bandwidth mode further comprises:
when the secondary channel is idle and the secondary channel does not have more serious fading than the primary channel, determining to use the first bandwidth mode; otherwise, determining to use the second bandwidth mode.

7. The rate adaptation method of claim 5, wherein the estimation values represent constellation errors of the primary channel and the secondary channel, respectively; and the rate adaptation method further comprises:
measuring the constellation errors of the primary channel and the secondary channel, respectively.

8. The rate adaptation method of claim 5, wherein the estimation values represent tone energy of the primary channel and the secondary channel, respectively; and the rate adaptation method further comprises:
measuring the tone energy of the primary channel and the secondary channel, respectively.

9. The rate adaptation method of claim 1, wherein the step of determining whether the secondary channel is idle further comprises:
determining whether the secondary channel is idle by detecting whether the secondary channel has been idle for a specific duration.

10. The rate adaptation method of claim 1, wherein the primary channel and the secondary channel represent frequency bands, respectively.

11. A rate adaptation method for a wireless communication apparatus, the rate adaptation method comprising:
determining at least one estimation value regarding communication quality of the wireless communication apparatus; and
determining whether to use a first guard interval (GI) mode or a second GI mode according to the estimation value, wherein the first GI mode and the second GI mode correspond to different values of an overall data rate of the wireless communication apparatus.

12. The rate adaptation method of claim 11, wherein the step of determining whether to use the first GI mode or the second GI mode further comprises:
determining whether to use the first GI mode or the second GI mode by comparing the estimation value with a threshold.

13. The rate adaptation method of claim 12, wherein the first GI mode represents a short GI mode, and the second GI mode represents a normal GI mode; and the step of determining whether to use the first GI mode or the second GI mode further comprises:
when the estimation value reaches the threshold, determining to use the short GI mode; otherwise, determining to use the normal GI mode.

14. The rate adaptation method of claim 11, wherein the estimation value represents a received signal strength.

15. The rate adaptation method of claim 11, wherein the estimation value represents a transmission data rate.

16. A wireless communication apparatus for performing wireless communication with rate adaptation, the wireless communication apparatus comprising:
a processing circuit determining at least one estimation value regarding communication quality of the wireless communication apparatus, and further determining whether to use a first mode or a second mode according to the estimation value, wherein the first mode and the second mode correspond to different values of an overall data rate of the wireless communication apparatus;
a wireless receiver, coupled to the processing circuit, for receiving data wirelessly according to the control of the processing circuit; and
a wireless transmitter, coupled to the processing circuit, for transmitting data wirelessly according to the control of the processing circuit.

17. The wireless communication apparatus of claim 16, wherein the estimation value corresponds to communication quality of a primary channel and/or a secondary channel for being utilized by the wireless communication apparatus; the first mode represents a first bandwidth mode, and the second mode represents a second bandwidth mode; and the processing circuit determines whether to use the first bandwidth mode or the second bandwidth mode according to whether the secondary channel is idle and according to the estimation value.

18. The wireless communication apparatus of claim 17, wherein the estimation value represents an abnormal clear channel assessment (CCA) occurrence rate regarding the primary channel and/or the secondary channel; and the processing circuit determines whether to use the first bandwidth mode or the second bandwidth mode according to the abnormal CCA occurrence rate.

19. The wireless communication apparatus of claim 17, wherein the processing circuit determines a plurality of estimation values corresponding to fading degrees of the primary channel and the secondary channel, respectively; and the processing circuit determines whether to use the first bandwidth mode or the second bandwidth mode according to whether the secondary channel has more serious fading than the primary channel.

20. The wireless communication apparatus of claim 16, wherein the processing circuit determines whether to use the first GI mode or the second GI mode by comparing the estimation value with a threshold.
